(19) United States
(12) Patent Application Publication
(10) Pub. No.: US 2012/0310713 A1
(43) Pub. Date: Dec. 6, 2012

(54) PRESENTING OFFERS TO CONSUMERS BASED ON INFORMATION FROM A VEHICLE

(75) Inventors: Marc E. Mercuri, Bothell, WA (US); James O. Tisdale, Duvall, WA (US)

(73) Assignee: MICROSOFT CORPORATION, Redmond, WA (US)

(21) Appl. No.: 13/152,261

(22) Filed: Jun. 2, 2011

(51) Int. Cl. G06Q 30/00

(52) U.S. Cl. 705/14.1

(57) ABSTRACT

An automotive incentive system is described herein that uses vehicle information, location data, customer demographics, and other information to make real-time targeted offers to consumers to encourage particular consumer behavior. The system focuses on the delivery of targeted offers to consumers based on information available from the automobile and geographic information from the car. The system receives vehicle-based information and potentially along with other information identifies one or more offers to provide to the consumer. The system provides an interface through which merchants can add offers to the system and define criteria of consumers and environmental data that trigger each offer. The merchant can specify each of these criteria as well as a corresponding offer. Thus, the automotive incentive system provides consumers with highly relevant offers related to vehicle information and provides merchants with strong sales leads for their products and services.

### BACKGROUND

Products and services have been sold in many ways throughout history. With the rise of the Internet, selling products and services has only changed slightly. Web pages often provide additional information to consumers before a purchase, and can provide additional assistance such as maps, contact information, and so forth, that help the consumer identify appropriate products and services and complete a purchase.

A common problem in selling products and services is reaching the right consumers that are likely to want to make a purchase. Advertising is one general form of reaching consumers. Advertising typically has a call to action that is designed to motivate a consumer to take action. Most often, this action takes the form of incenting the consumer to purchase a product or service. Advertisers work hard to quantify the demographics of audiences that will be reached with a particular advertisement, so that merchants can advertise to consumers that are the most likely to buy the merchant's products or services. The Internet has provided additional refinements to advertising, such as the ability to associate advertisements with search keywords, in the hope that the search keywords are a good reflection of a consumer's current interests.

Despite these improvements, there are numerous unmet consumer needs and consumers that would buy a product or service that are not reached by current advertising methods. With advancements in mobile devices, and particularly the broad availability of consumer location information, there is quite a bit of additional consumer information that is not presently available to advertisers and merchants. While today we focus on phones, tablets, and laptops in the mobile device category, we will very quickly include a much more mobile device—the automobile. Connected cars are starting to make their way to the marketplace and software companies are increasingly focused on the development of car-centric applications.

### SUMMARY

An automotive incentive system is described herein that uses vehicle information, location data, customer demographics, sensor data, and other information to make real-time targeted offers to consumers to encourage particular consumer behavior. The system focuses on the delivery of targeted offers to consumers based on information available from the automobile and geographic information from the car. The automotive incentive system receives vehicle-based information and potentially along with other information identifies one or more offers to provide to the consumer. The system provides an interface through which merchants can add offers to the system and define criteria of consumers and environmental data that trigger each offer. The merchant can specify each of these criteria as well as a corresponding offer. The merchant may also specify some action the merchant wants the consumer to perform to become eligible for the offer. Thus, the automotive incentive system provides consumers with highly relevant offers related to vehicle information and provides merchants with strong sales leads for their products and services.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the automotive incentive system, in one embodiment.

FIG. 2 is a flow diagram that illustrates processing of the automotive incentive system to receive an offer from a merchant that incentivizes consumers to purchase the merchant's products or services using vehicle information to match to consumers, in one embodiment.

FIG. 3 is a flow diagram that illustrates processing of the automotive incentive system to deliver an offer from a merchant to a consumer matched to the consumer based on vehicle information and that incentivizes the consumer to purchase the merchant's products or services, in one embodiment.

FIG. 4 is a block diagram that illustrates typical actors associated with the automotive incentive system, in one embodiment.

### DETAILED DESCRIPTION

An automotive incentive system is described herein that uses vehicle information, location data, customer demographics, and other information to make real-time targeted offers to consumers to encourage particular consumer behavior. The system focuses on the delivery of targeted offers to consumers based on information available from the automobile and geographic information from the car. For example, the following types of scenarios are supported by the system.

An automobile identifies that a car has driven a certain number of miles and requires service of some kind (e.g., oil change, tire rotation, and so forth). This information and geographic information (e.g., the consumer's current location or frequent start/stop locations for global positioning system (GPS) routes that may indicate home or work) is communicated to an opt-in service that provides offers from an advertising network. An automobile detects that it is low on gas. This information along with relevant targeting information (e.g., car make, gas tank size, owner demographics, and so on) is delivered to an opt-in service that evaluates this data and serves up targeted offers (e.g., gas discounts, discounts on food items or services such as a car wash, and so forth). An automobile detects that it has been driven for greater than six hours and it is currently late in the evening. This information and current location and GPS route information is sent to an opt-in service that identifies hotels on the route and provides any targeted offers for hotel rooms (a high margin item). An automobile detects that it is currently a standard mealtime (e.g., breakfast, lunch, dinner, and late night) and utilizes current location and/or GPS route information to provide targeted offers for discounts on meals, recommend restaurants based on preferences, and so on. An automobile detects certain environmental data (e.g., outside temperature) to provide targeted offers. An automobile detects frequent acceleration/braking, distance between itself and other automobiles using cameras or other sensors, and so forth to detect that the consumer is in significant traffic and in conjunction with demographic information presents targeted offers (e.g., download cartoon videos for children who may be in the back seat, dial the phone number for a restaurant to pick up dinner at a discount, and so forth).

In each of these examples, the automotive incentive system receives some vehicle-based information and potentially along with other information identifies one or more offers to provide to the consumer. In some embodiments, the system provides an interface through which merchants can add offers to the system and define criteria of consumers and environmental data that trigger each offer. For example, one vendor may want to reach consumers in a certain age range, within a certain distance from a location, facing a certain condition (e.g., low gas), and so forth. The merchant can specify each of these criteria as well as a corresponding offer (e.g., $5 off gas, free meal with fill up, and so on). The merchant may also specify some action the merchant wants the consumer to perform to become eligible for the offer. For example, the merchant may indicate that if the consumer buys $10 of gas, the consumer will be eligible for a $5 discount on a meal. Incentives may be designed by merchants to get consumers to visit their store. Thus, the automotive incentive system provides consumers with highly relevant offers related to vehicle information and provides merchants with strong sales leads for their products and services.

In some embodiments, the system provides incentives for consumers to visit a particular merchant's store. For example, the system may offer to unlock a digital content item, such as a song by the consumer's favorite band, if the consumer goes to the merchant's store. Merchants can define various offers and conditions (e.g., spending a certain amount of time at the store) for which the consumer can earn the incentive. The incentive may be provided by the merchant or may be matched to various incentives available from the system operator provided by other merchants. For example, a merchant may be willing to pay a certain amount of money for each consumer visit to their store, and another merchant may be willing to hand out promotional material to consumers of the same demographic. The system can match these two together to allow the first merchant to get visits to his store, and the second merchant to raise awareness of her digital content.

In some embodiments, the automotive incentive system uses location information and targeted offers to unlock digital marketing content and to encourage the consumer to visit a location. In this case, the content provides the incentive to the consumer, and the offer encourages behavior to visit a location previously defined by a merchant of a product or service. Many opportunities present themselves when the system can utilize the location of a consumer via a mobile device and utilize that (and potentially multiple other pieces of information) to drive engagement with a consumer. This engagement can incentivize a consumer to visit a physical location (e.g., a store or a department in a store), provide offers to people within a physical location (at the mall), and may consider secondary information (e.g., reputation, purchase history, and identified need). If the consumer visits the location, the merchant may gain increased sales and the consumer gains a wanted content item.

In some embodiments, the automotive incentive system receives information about the consumer, such as the consumer's schedule, past purchase history, demographic information (e.g., age, gender, and social groups), needs, or direct input (“I'm hungry”), and so forth. For example, the consumer may run an application on the consumer's smartphone or other mobile device (or via a computer in the car itself) that has access to information shared by the consumer. The system can use this information to present offers that are more relevant. For example, if the consumer gets a haircut roughly every four weeks, has availability in his afternoon schedule, and a local barber has submitted an offer with a schedule that matches the consumer's, the system may offer the consumer an incentive to visit the barber to get a haircut. In some embodiments, the offer for the haircut would only be made if the consumer were free during that period and nearby. The incentive may include a coupon for a discount on the barber's services, an offer to unlock digital content, or any other incentive.

In some embodiments, the automotive incentive system presents real-time limited offers to consumers based on vehicle information, location, purchase history, and assumed need. A merchant or a consumer can use the system to fill a schedule based on the needs of either. For example, an oil change shop may have no line on a slow afternoon, and can make offers to nearby consumers with vehicles that need oil changes in real-time to come and get an oil change. The system may use information about each consumer such as whether the consumer owns a car, whether the consumer has purchased an oil change in the last few months, whether vehicle information indicates a need for an oil change, whether the consumer has time in the consumer's schedule for an oil change, and so forth without that detailed information ever being made available to the merchant. In this way, the system matches merchant needs to consumer needs in a way that facilitates commerce at a time that is convenient for all parties involved. In this example, the merchant may smooth out what would otherwise have been a busy weekend schedule by pushing more demand into the week, and the consumer may save money using a coupon that is part of the offer and get something done that the consumer needed to do anyway, during a time when the consumer was available. In such embodiments, the system focuses on matching any aspect of merchant or consumer needs together based on all of the available information from each.

In some embodiments, the automotive incentive system provides incentives to attempt to modify consumer behavior. For example, a particular type of merchant may want to reach the consumers of the merchant's competitors to try to win the consumers as customers. Thus, the system may present an offer from the merchant when consumers are detected at the location of a competitor or when the system predicts that the customer may be heading to the competitor to offer the consumers an incentive to visit the merchant's store. For example, a consumer at one restaurant may receive a coupon to visit another restaurant. The system may use any of the previously described information, such as past purchase history, to suggest appropriate offers to a particular consumer, and to match the consumer with offers submitted by particular merchants.

In some embodiments, the automotive incentive system uses vehicle information, location, and consumer purchase history to present offers that attempt to change typical consumer behavior. In the previous example, the system incentivized the consumer to do something the consumer already typically does (e.g., get an oil change or a haircut through repeat business to a known merchant). In this example, the system incentivizes the consumer to do something new or to use a competing merchant for a common product or service. For example, a routine customer of restaurant X is nearby restaurant Y where the consumer has not dined before. Restaurant Y can generate an offer to encourage any nearby consumers with certain criteria to dine at restaurant Y. The incentive may include a coupon, offer for digital content, or other item desirable to the consumer. The system may make the offer based on information about the current time compared to the consumer's typical mealtime, the consumer's proximity to the new restaurant, the consumer's preference for a type of food served by the restaurant, and so forth. As another example, the system may present a consumer that is typically a customer of BP Gasoline with an offer for a nearby Shell Station for a free car wash with fill up. In this way, the system allows merchants to solicit new customers.

In some embodiments, the automotive incentive system attempts to reach consumers that are already at a location to perform some behavior. For example, a store in a mall may want to reach out to visitors to the mall to let them know about a particular sale or product for which the store has excess inventory. Upon detecting that a matching consumer is at the location, the system may present an offer to the consumer informing the consumer of the merchant's offer. Thus, the automotive incentive system provides incentives to help merchants sell products and services by reaching more consumers and reaching them in new ways that are highly relevant to the consumers' current activities and location.

In some embodiments, the automotive incentive system uses vehicle information, location, consumer reputation, demographics, and other information to present offers while a consumer is at a location that may unlock digital offers or provide other incentives to the consumer. In the earlier example, the system presented offers that incentivized consumers to visit a particular location. In this example, the system instead provides incentives to consumers because they are already at a particular location. The system can use location in conjunction with a consumer's reputation or other information to make a targeted offer that can be redeemed at nearby businesses. Some examples include: a) Restaurant A wishes to increase their traffic, (b) Restaurant B can provide discounts for students on the honor role, (c) Restaurant C can make dynamic offers to people on their birthday (even if they have not previously visited the restaurant before), (d) Restaurant D may wish to attract more members of a particular demographic (income, age, etc.) and offer targeted discounts, (e) Nightclub A may want to attract more women and offer free admission, (f) Bar B may be hosting a sporting event and invite a known fan who might otherwise be unaware of the bar, (g) a local bar, looking for more visibility, may provide discounts to people with a significant number of followers on Facebook, (h) a camera store may offer discounts to someone who has a lot of followers and is very active on Flickr or another social network, and (i) a local UPS Store may offer discounts or free packing materials to individuals that are Power Sellers on eBay or other merchants. These and other examples provide offers to the consumer based on the consumer's present location and some other information about the consumer that makes the offer particularly relevant to the merchant or consumer.

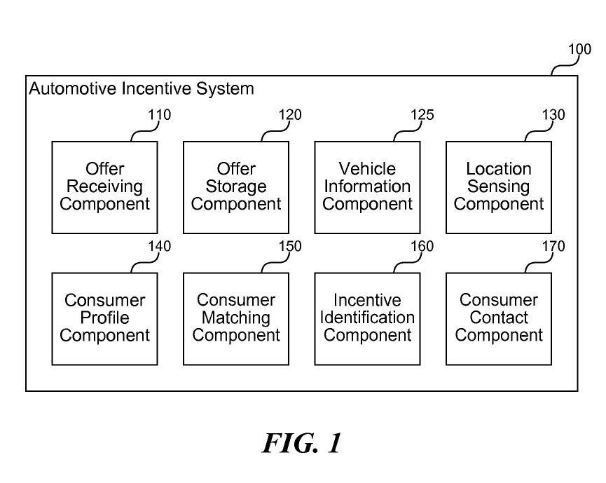

FIG. 1 is a block diagram that illustrates components of the automotive incentive system, in one embodiment. The system 100 includes an offer receiving component 110, an offer storage component 120, a vehicle information component, a location sensing component 130, a consumer profile component 140, a consumer matching component 150, an incentive identification component 160, and a consumer contact component 170. Each of these components is described in further detail herein.

The offer receiving component 110 receives one or more offers from one or more merchants, the offers designed to incentivize consumer behavior. The offer may include an indication of a desired behavior of a consumer, such as visiting a location associated with the merchant, completing a task, purchasing a product, recommending a product to a friend, and so on. The offer receiving component 110 may provide a user interface, such as a web page or software application, through which merchants can define, save, schedule, and activate various offers to consumers to promote the merchants' products and services. The offer receiving component 110 may also receive consumer profile information against which the merchant wants to match vehicle, demographic, and other information of eligible consumers as a precondition for the consumers to receive the offer. For example, a merchant may want to market a particular product to female consumers having large cars that have purchased sports products in the last week (i.e., soccer moms). The merchant can specify these and other conditions through the offer receiving component 110. The offer may include other criteria, such as a quantity of the incentive available, such that after that quantity of consumers have accepted or used the offer, the system stops matching new consumers with the offer. The offer receiving component 110 stores current offers in the offer storage component 120 for subsequent matching to consumers via the consumer matching component 150. The offers may include schedules or other time limitations that specify a period during which the offer is matched with consumers.

The offer storage component 120 stores one or more received offers for subsequent matching to consumers. The component 120 may include one or more file systems, hard drives, portable storage devices, databases, cloud-based storage services, or other data storage facility for persisting data over time. The offer storage component 120 stores offers and any associated conditions such as consumer profiles, offer schedules, and so forth. The component 120 is accessible by other components of the system 100 to perform various operations related to consumer offers.

The vehicle information component 125 receives information from a vehicle associated with at least one consumer. Vehicles today include a wide variety of information in various forms. For example, most vehicles include an on-board computer system that manages the mechanical operation of the vehicle. Many of these systems provide standard interfaces, such as On-Board Diagnostics (OBD) I and II, that can be accessed through a common connector via a hardware device associated with the system. Information available from these computer systems includes vehicle speed, miles driven, time since last maintenance, various component states of the engine's components, how long the vehicle has been operated (overall or on a particular day), and so forth. The system can use this information to feed a variety of decisions and to match the consumer with offers related to the vehicle's maintenance needs, the consumer's meal and rest needs, and so on.

Many vehicles also include computer systems related to consumer comfort, such as Ford and MICROSOFT™ Sync, which provides a variety of multimedia, vehicle management, voice activation, and other technologies for use in a vehicle. Such systems can also interface with other systems, such as the automotive incentive system 100, to provide information about what is going on in the vehicle, needs of the occupants or the vehicle, and so forth. Vehicles may also include other peripheral computing devices that interface with the vehicle, such as a consumer's mobile phone connected via a Bluetooth or other interface, a GPS device, an emergency assistance device (e.g., GM's On-Star system), and so on. All of these systems can interface with and provide information to the vehicle information component 125.

The location sensing component 130 detects a consumer's current location with a device associated with the consumer or vehicle and provides the detected location to other components of the system for presenting dynamic offers for products or services to the consumer. The device may include a mobile phone, in-car GPS device, keychain, watch, or any other device with a global positioning system (GPS), cell tower triangulation, or other hardware that can identify location. The location sensing component 130 may provide location information as latitude and longitude components, cross-streets, or other data point that allows merchants to associate offers with a particular location and allows the system to determine whether a consumer is within a predetermined proximity of the location. If the consumer is within the predetermined proximity of a location associated with the offer, then based on whether other conditions of the offer match the consumer, the consumer matching component 150 will select consumers to which to deliver the offer. In some embodiments, the component 130 identifies consumers that are at a location to which to present offers of merchants near the consumer.

The consumer profile component 140 gathers and provides profile information related to one or more consumers to components of the system 100 to match against one or more offer conditions that a merchant previously specified in an offer. In some embodiments, the component 140 gathers past consumer purchase information to identify purchases from competitors of a merchant that has submitted an offer designed to change consumer behavior to use the merchant's products or services. The consumer profile component 140 can gather purchase history, consumer needs, consumer schedule information (e.g., from a calendar application used by the consumer), demographic information (e.g., age, sex, height, social groups), and any other information associated with the consumer. The consumer profile component 140 may receive one or more privacy preferences from the consumer that indicate which information the consumer will allow the system 100 to use for matching the consumer with merchant offers. The consumer may choose not to share some information or to restrict the manner in which information is shared to a mode that allows anonymity. The component 140 attempts to provide the consumer with offers that the consumer will want to receive without sacrificing the consumer's privacy or exposing personal information. However, with the consumer's permission, the system may provide to merchants information that allows the merchants to more effectively select products, services, and offers of interest to the consumer.

The consumer matching component 150 matches one or more received offers to one or more consumers, based on the consumer's detected location and one or more conditions associated with the offer. The component 150 may match consumers to offers based on needs of the consumer, needs of the merchant (e.g., an open slot in the merchant's schedule or time-based quota for sales), consumer profile information versus profile criteria specified in the offer, one or more businesses associated with the consumer's current location, and so forth. The matching component 150 endeavors to find offers for the consumer that will result in the consumer purchasing a merchant's product. To this end, the component 150 may determine a relevance of a particular offer to a particular consumer based on information provided by the merchant, provided by the consumer, and/or determined by the system 100. For example, in some embodiments the component 150 determines needs of one or more merchants, needs of one or more consumers, and matches the determined needs to determine one or more pairs of consumers and merchants between which to exchange an offer for purchase of a product or service. The system 100 may track heuristics such as which types of consumers have responded positively to a particular incentive or offer, so that the system can adapt the matching and/or inform merchants what is working so merchants can design offers that are more effective.

The incentive identification component 160 determines an incentive that is likely to influence behavior of the consumer to perform an action associated with a selected merchant offer. In some cases, the merchant may explicitly specify an appropriate incentive at the time of defining the offer, so that if consumers perform a specified action they will receive the specified incentive. In some embodiments, the component 160 dynamically determines an appropriate incentive based on information such as how much the merchant is willing to pay to engage the consumer, interests of the consumer, other consumer profile information, incentives offered by other merchants, and so forth. The incentive may include unlocking digital content if the consumer performs the specified action, as handled by the content unlock component 180.

The consumer contact component 170 contacts one or more consumers to which the system 100 matched one or more merchant offers to inform the consumers of the offer and the determined incentive. For example, the component 170 may send the consumer a text message, email message, pop-up notification or other communication that indicates the details of the offer (e.g., merchant, call to action, and incentive) so the consumer can determine if the consumer will perform the specified behavior to receive the specified incentive. The consumer may reply to the offer by visiting the merchant, by indicating a willingness to accept the offer through a direct reply to the notification, or through other actions of the consumer (e.g., recommending the offer to one or more of the consumer's friends).

The computing device on which the automotive incentive system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

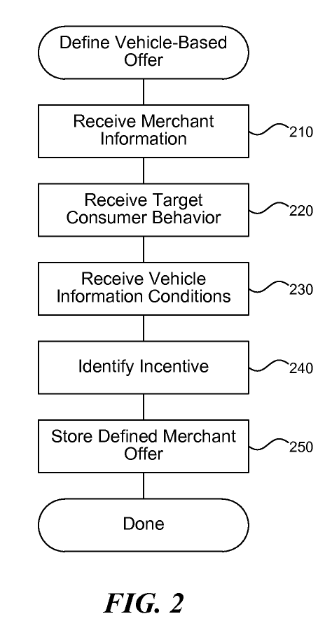

FIG. 2 is a flow diagram that illustrates processing of the automotive incentive system to receive an offer from a merchant that incentivizes consumers to purchase the merchant's products or services using vehicle information to match to consumers, in one embodiment. Beginning in block 210, the system receives identification information related to a merchant and one or more locations associated with the merchant. For example, the information may include a business name and a street address of the business. The system may provide a user interface through which merchants can enter their information in a merchant profile or other stored record and create offers to incentivize consumers to visit their locations to purchase products or services. The merchant may define one or more offers through the user interface, which may include a web page, mobile application, or other interface through which merchants access the system.

Continuing in block 220, the system receives target consumer behavior that includes visiting a location associated with the merchant. The system helps merchants incentivize consumers to visit their businesses by communicating one or more offers from the merchant to the consumer and offering an incentive. The target consumer behavior may include receiving a signal from the consumer's mobile device indicating that the consumer is at the merchant's location, spending a certain amount of time at the merchant's location, visiting a particular sub-location (e.g., a department within a store), visiting a merchant hotel, visit a merchant gas station, buying particular products, and so forth.

Continuing in block 230, the system receives one or more consumer vehicle information conditions that filter the types of consumers that will receive an offer to visit the merchant's location based on information available from a vehicle. The conditions may include various information and criteria associated with consumers that is available to the system, such as miles driven, due for service, fuel level, location, car make, gas tank size, type of fuel, owner demographics, driving time, time of day, outside temperature, under hood temperature, in-car temperature, acceleration/braking frequency, distance to other cars, demographic information, past purchase history, consumer preferences, social networks that the consumer participates in, and so on. The conditions may also include information that is more dynamic, such as targeting consumers that are presently at a particular location or that have been at a particular location in recent history, targeting consumers within a certain distance of the merchant location, targeting consumers that are currently performing a particular activity, and so forth.

Continuing in block 240, the system identifies an incentive to entice consumers matching the received vehicle information conditions to visit the merchant's location and perform the target consumer behavior. The incentive may include things like a gas discount, discount on food, free digital content, free map, or a free car wash. The system may receive a specific incentive or digital content item from the merchant during creation of the offer or may select an incentive from other sources, such as received third-party incentives and promotional material. The digital content may include a song, video, credits at a web-based store, items in a game, tickets to a movie, or any other unlockable content that the system can provide to the consumer as a reward for performing the target consumer behavior. For example, the system may provide the consumer with access to a preview video of a new movie in return for the consumer visiting the merchant's store for 10 minutes.

Continuing in block 250, the system stores a defined offer from the merchant that includes the received merchant information, target consumer behavior, vehicle information conditions, and identified incentive. The system may provide a market of merchant offers through an application run by consumers on a mobile or other device (e.g., a vehicle-based computer system), such that the device at any given time can monitor and select appropriate offers based on the consumer's location, needs, current activities, and so forth. After block 250, these steps conclude.

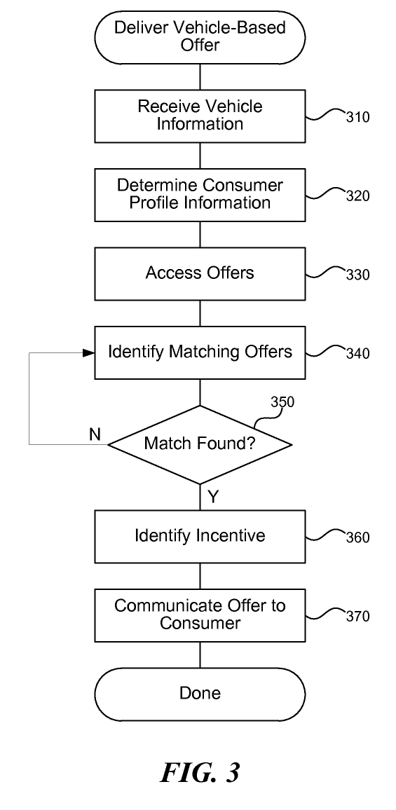

FIG. 3 is a flow diagram that illustrates processing of the automotive incentive system to deliver an offer from a merchant to a consumer matched to the consumer based on vehicle information and that incentivizes the consumer to purchase the merchant's products or services, in one embodiment. Beginning in block 310, the system receives vehicle information derived from a vehicle associated with a consumer. The vehicle information may include miles driven, due for service, fuel level, car make, gas tank size, type of fuel, driving time, time of day, outside temperature, under hood temperature, in-car temperature, acceleration/braking frequency, distance to other cars, or other vehicle-based information. The system may receive the information from an in-vehicle computer system, such as an on-board computer that manages the mechanical operation of the vehicle, a computer system that interacts with the consumer, a mobile device associated with the consumer that is docked in the vehicle, and so on.

Continuing in block 320, the system determines consumer profile information that defines additional information about the consumer. The information may include location, frequent start/stop locations for GPS routes, habits of the consumer, the consumer's schedule, consumer demographics information, and so forth. A merchant may want to limit the offer to the consumers that the merchant believes are most likely to accept the offer, and to those that will be most interested in the offer. There may be a cost to the merchant for offers made (either directly as charged by the system or indirectly as consumers develop a negative opinion of the merchant based on irrelevant offers), such that the merchant acts to make offers highly targeted and relevant to consumers. The consumer profile information in combination with the received vehicle information allows merchants to make highly targeted offers.

Continuing in block 330, the system accesses one or more previously stored offers defined by a merchant to encourage target consumers to perform an identified behavior related to the merchant's products or services. For example, an offer may ask consumers to visit a location associated with the merchant to receive access to digital content. The system may store a pool of offers from which the system can select at any time and match to consumers that subscribe to a service or run a mobile application associated with the system. The system may provide a central server or other repository that multiple consumer vehicles or other mobile devices can access to search for relevant offers for the consumer.

Continuing in block 340, the system identifies one or more offers that match the received vehicle information and consumer profile information to matching criteria associated with the offer. The system may determine demographic information of the target consumers, past behavior information, or any other information describing the consumers that helps the system to target offers more effectively. If the merchant specifies specific criteria (e.g., male consumers age 20-24 within 5 miles of the merchant's store), then the system monitors consumers using the system to determine any change that may cause a consumer to match a particular offer's criteria.

Continuing in decision block 350, if one or more matching offers were found, then the system continues at block 360, else the system loops to block 340 to continue looking for matching offers. The system may monitor for matching offers whenever the consumer is in the vehicle or at other appropriate times.

Continuing in block 360, the system identifies an incentive associated with the matching offer for delivery to the consumer. The incentive may be specified by the merchant and stored with the previously stored offer or may be dynamically determined by the system. In some cases, a merchant may identify different incentives for different target consumers, such as passes to one movie for young adults and passes to a different movie for middle-aged adults (or by gender or other criteria). The incentive may include actions with the consumer's car, such as asking the consumer to drive to a particular location, get a car wash, fill up the consumer's gas tank, and so on.

Continuing in block 370, the system contacts the consumer and offers the identified incentive to the consumer in return for performing the identified behavior requested by the matching merchant offer. The system may identify an email address, SMS phone number, device identifier for pop-up notification, or other contact address for reaching the consumer and send a message that indicates the offer and incentive. For example, the system may send a text message indicating that if the consumer visits Macy's three blocks away, the consumer can unlock access to passes to the latest Twilight movie.

To deliver the offer, the system identifies a mobile device of the identified consumers through which the consumer can be contacted. For example, the consumers may run an application associated with the system or provide contact information through a web site or other user interface provided by the system. In some embodiments, the system uses GPS or other hardware of the consumer's mobile device to present offers based on the consumer's location and other criteria associated with one or more merchant offers. After block 370, these steps conclude.

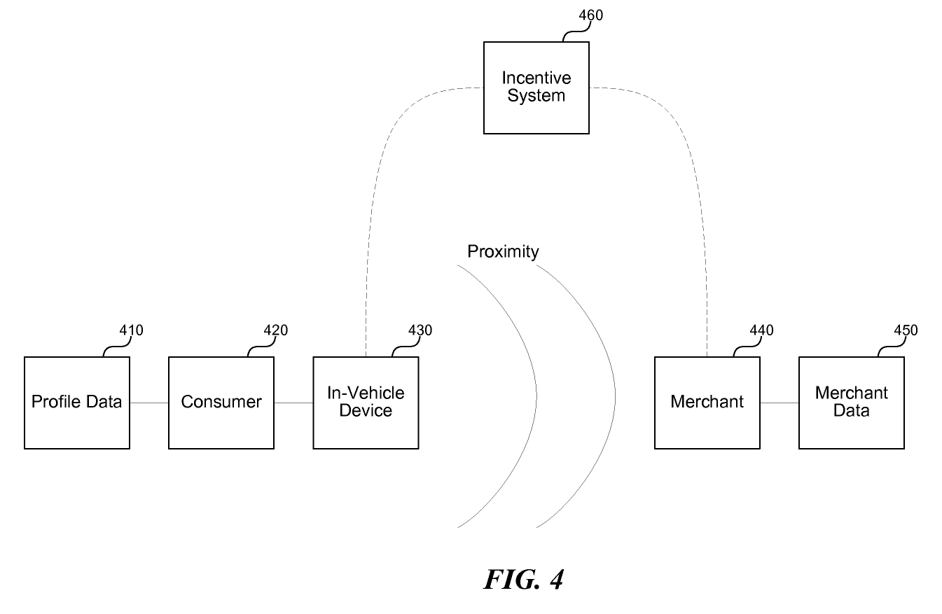

FIG. 4 is a block diagram that illustrates typical actors associated with the automotive incentive system, in one embodiment. A consumer 420 has an in-vehicle device 430 and associated profile data 410 that may be stored on the in-vehicle device 430, with the incentive system 460, or elsewhere. A merchant 440 has associated merchant data 450 that may include offers, incentives, location information, or other data. Based on the proximity of the in-vehicle device 430 to the merchant 440, or based on other criteria, the incentive system 460 delivers offers to the consumer's in-vehicle device 430 to incentivize the consumer 420 to purchase products or services from the merchant 440. The merchant 440 can tailor offers along a variety of criteria to reach various consumers and meet various needs of the merchant 440 and/or consumers.

In some embodiments, the automotive incentive system provides consumer information to merchants without directly exposing private information of the consumer. Consumers using the system can receive finely tuned offers based on likes/dislikes, actions, location, and so forth, and in doing so they do not necessarily have to give up any private information to a merchant or advertiser. The consumer shares needs with the system, but not personally identifiable information. For example, the system may receive information that a consumer is hungry and search for restaurants near the consumer that have available offers, but not give the restaurant owner the consumer's identity. Similarly, if a merchant wants to reach consumers that fit a particular profile (e.g., live in a specific zip code, have a certain income level, of a certain age), the system can find such consumers and deliver offers without providing the consumers' information to the merchant. Thus, the system receives highly personalized sets of criteria without necessarily exposing personal information. In some situations, consumers may choose to provide personal information in exchange for some benefit, but the system can operate without them doing so.

In some embodiments, the automotive incentive system works with vehicles not driven by the consumer. For example, the system may work with public transit vehicles, vehicles in which the consumer is a passenger, trains, ferries, boats, and so forth. The system is not limited to cars or any particular type of vehicle, but rather can use and leverage any type of vehicle-based information that the system receives to identify and target offers to consumers that are made relevant by the consumer's current activities or status related to a vehicle. In some embodiments, the system may detect locations where a consumer enters or exits a vehicle, to make targeted offers based on a consumer's frequent location. The system can also be applied to non-vehicular sources of information. For example, many homes are becoming “smart homes” in which the home has an associated computer system that monitors information available within the home, such as electricity usage, activities of occupants, temperature, and so forth.

From the foregoing, it will be appreciated that specific embodiments of the automotive incentive system have been described herein for purposes of illustration, but that various modifications may be made without deviating from the spirit and scope of the invention. Accordingly, the invention is not limited except as by the appended claims.

I/We claim:

1. A computer-implemented method to deliver an offer from a merchant to a consumer matched to the consumer based on vehicle information and that incentivizes the consumer to purchase the merchant's products or services, the method comprising:
receiving vehicle information derived from a vehicle associated with a consumer;
determining consumer profile information that defines additional information related to the consumer;
accessing one or more previously stored offers defined by a merchant to encourage target consumers to perform an identified behavior related to the merchant's products or services;
identifying one or more offers that match the received vehicle information and consumer profile information to matching criteria associated with the offer;
upon finding at least one matching offer, identifying an incentive associated with the matching offer for delivery to the consumer; and
contacting the consumer and offering the identified incentive to the consumer in return for the consumer performing the identified behavior requested by the matching merchant offer, wherein the preceding steps are performed by at least one processor.

2. The method of claim 1 wherein receiving vehicle information comprises receiving information selected from the group consisting of miles driven, service status, fuel level, car make, gas tank size, type of fuel, driving time, time of day, outside temperature, under hood temperature, in-car temperature, acceleration frequency, braking frequency, video camera input, and distance to other vehicles.

3. The method of claim 1 wherein receiving vehicle information comprises receiving information from a computer system associated with or present within the vehicle.

4. The method of claim 1 wherein receiving vehicle information comprises receiving information from an on-board computer that manages the mechanical operation of the vehicle.

5. The method of claim 1 wherein receiving vehicle information comprises receiving information from a manufacturer or aftermarket vehicle computer system that interacts with the consumer.

6. The method of claim 1 wherein receiving vehicle information comprises receiving information from a mobile device associated with the consumer that is docked in the vehicle.

7. The method of claim 1 wherein determining consumer profile information comprises accessing consumer demographic information to limit a merchant offer to a particular demographic group of consumers.

8. The method of claim 1 wherein accessing offers comprises accessing offers from a server from an in-vehicle computer system to find offers relevant for a consumer currently in the vehicle.

9. The method of claim 1 wherein identifying matching offers comprises monitoring consumers to determine any change that may cause a consumer to match a particular offer's criteria.

10. The method of claim 1 wherein identifying the incentive comprises accessing an incentive specified by the merchant and stored with the previously stored offer.

11. The method of claim 1 wherein identifying the incentive comprises dynamically determining an incentive based on the vehicle information and determined consumer profile information.

12. The method of claim 1 wherein identifying the incentive comprises identifying an incentive that includes one or more actions with the consumer's vehicle.

13. The method of claim 1 wherein contacting the consumer comprises identifying an email address, SMS phone number, device identifier for pop-up notification, Bluetooth address, Infrared endpoint, radio frequency, near field communication endpoint, or other contact address for reaching the consumer and sending a message that indicates the offer and incentive.

14. A computer system for presenting offers to consumers based on information from a vehicle, the system comprising:
a processor and memory configured to execute software instructions embodied within the following components;
an offer receiving component that receives one or more offers from one or more merchants, the offers designed to incentivize consumer behavior;
an offer storage component that stores one or more received offers for subsequent matching to consumers;
a vehicle information component that receives information from a vehicle associated with at least one consumer;
a location sensing component that detects a consumer's current location with a device associated with the consumer or vehicle and provides the detected location to other components of the system for presenting dynamic offers for products or services to the consumer;
a consumer profile component that gathers and provides profile information related to one or more consumers to components of the system to match against one or more offer conditions that a merchant previously specified in an offer;
a consumer matching component that matches one or more received offers to one or more consumers, based on received vehicle information and one or more conditions associated with the offer; and
a consumer contact component that contacts one or more consumers to which the system matched one or more merchant offers to inform the consumers of the offer.

15. The system of claim 14 wherein the offer receiving component also receives consumer profile information against which the merchant wants to match vehicle information of eligible consumers as a precondition for the consumers to receive the offer.

16. The system of claim 14 wherein the vehicle information component receives information from an on-board computer system or other computer system associated with the vehicle that manages the mechanical operation of the vehicle.

17. The system of claim 14 wherein the vehicle information component receives information to match the consumer with offers related to the vehicle's maintenance needs.

18. The system of claim 14 wherein the vehicle information component receives information describing what is going on in the vehicle and one or more needs of the occupants or the vehicle.

19. The system of claim 14 wherein the vehicle information component receives information from a mobile device associated with the consumer that is present in the vehicle.

20. A computer-readable storage medium comprising instructions for controlling a computer system to receive an offer from a merchant that incentivizes consumers to purchase the merchant's products or services using vehicle information to match to consumers, wherein the instructions, upon execution, cause a processor to perform actions comprising:
receiving identification information related to a merchant and one or more locations associated with the merchant;
receiving target consumer behavior that includes visiting a location associated with the merchant;
receiving one or more consumer vehicle information conditions that filter the types of consumers that will receive an offer to visit the merchant's location based on information available from a vehicle;
identifying an incentive to entice consumers matching the received vehicle information conditions to visit the merchant's location and perform the target consumer behavior; and
storing a defined offer from the merchant that includes the received merchant information, target consumer behavior, vehicle information conditions, and identified incentive.
